(19) United States
(12) Patent Application Publication
(10) Pub. No.: US 2015/0274073 A1
(43) Pub. Date: Oct. 1, 2015

(54) METHOD AND APPARATUS FOR FORWARDING ITEMS OF INTEREST

(71) Applicant: MOTOROLA SOLUTIONS, INC., Schaumburg, IL (US)

(72) Inventors: MOHIT YOGESH MODI, AHMEDABAD (IN); TYRONE D. BEKIARES, PARK RIDGE, IL (US); SATYANARAYANA TUMMALAPENTA, BANGALORE (IN); STEVEN D. TINE, BUFFALO GROVE, IL (US)

(73) Assignee: MOTOROLA SOLUTIONS, INC, Schaumburg, IL (US)

(21) Appl. No.: 14/230,638

(22) Filed: Mar. 31, 2014

(51) Int. Cl. B60R 1/00; H04N 7/18

(52) U.S. Cl. CPC B60R 1/00; H04N 7/183

(57) ABSTRACT

A method and apparatus for providing information on an item of interest is provided herein. During operation a server will determine a vehicle's speed and direction. Information on items of interest will then be provided to the vehicle/user based on the vehicle speed and direction.

### FIELD OF THE INVENTION

The present invention generally relates to forwarding items of interest to a user, and more particularly to a method and apparatus for forwarding information on items of interest (such as a camera video stream), based on vehicle speed and direction.

### BACKGROUND OF THE INVENTION

In many public-safety applications, video streams from multiple surveillance systems may be provided to public-safety officer's vehicles. In most cases, the video stream is manually chosen by the officer. It is often an inconvenience for an officer in a moving vehicle to choose a relevant video stream from multiple cameras. For example, a video stream from a camera may continue to be provided to the officer after the vehicle has left the vicinity of the camera, requiring the officer to manually change to a more-relevant video stream.

It would be beneficial if an automated technique could be utilized for providing information on items of interest (such as relevant video streams from cameras of interest) to an individual in a moving vehicle, without requiring the driver's attention to do so. Therefore, a need exists for a method and apparatus for autonomously providing information on items of interest (such as a camera video stream) to a moving vehicle, yet does not require the driver's attention to choose the appropriate information.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates an operational environment for utilizing the present invention.

FIG. 2 illustrates a changing geometric shape based on speed and direction of travel.

FIG. 3 illustrates a changing geometric shape based on speed and direction of travel.

FIG. 4 is a block diagram of the dispatch center of FIG. 1.

FIG. 5 through FIG. 8 illustrate a geographic area as a vehicle travels from point to point.

FIG. 9 illustrates a changing geometric shape based on anticipated route of travel.

FIG. 10 is a flow chart showing operation of the dispatch center of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above, mentioned need, a method and apparatus for providing information on an item of interest is provided herein. During operation a server will utilize a vehicle's speed and direction. Information on items of interest will then be provided to the vehicle/user based on the vehicle speed and direction. For example, if a vehicle is moving at 60 miles per hour, occupants of the vehicle will probably be more interested in information on/from items of interest in front of them than from behind them. With this in mind, a two-dimensional or three dimensional figure, shape, or region can be overlaid onto a geographic area. Information on items of interest that lie within the figure, shape, or region may be provided to the user. These items of interest may be prioritized, with the closest item to the vehicle (and within the figure, shape, or region) having a highest priority. Information on highest priority items of interest will be provided to the vehicle/user before lower priority items of interest.

It should be noted that with the above scheme of providing information, it is not necessary that information on the closest item be provided to the user/vehicle. If an item is outside the figure, shape, or region, information on that item will not be provided. For example, consider a vehicle moving at a high rate of speed down an interstate. An occupant of the vehicle is interested in information such as the location of gas stations. The figure, shape, or region may comprise an area some distance in front of the vehicle. Thus, information on those gas stations behind the vehicle or immediately in front of the vehicle will not be provided to the user.

Prior to describing the present invention, the following definitions are provided to aide in understanding the present invention.
Item—any building, business, electronic device, or thing having a physical, geographic location.
Figure, Shape, or Region—an area projected onto a map. The figure, shape, or region will have its shape and size change depending upon a velocity and a direction of a vehicle.
Item of Interest—Any item residing within a figure, shape, or region.
Area of Interest—A geographic area that lies beneath a figure, shape, or region.

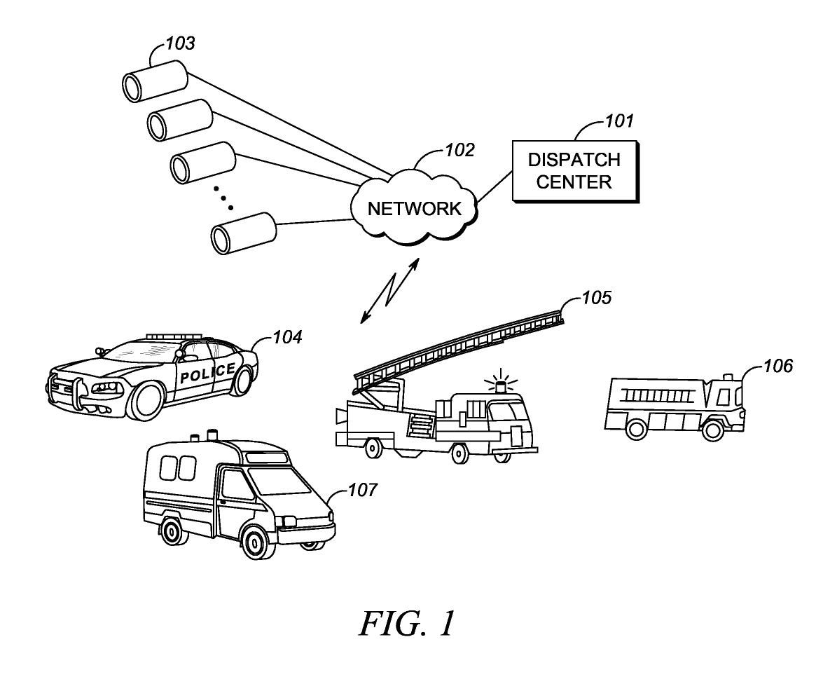

FIG. 1 is a block diagram showing a general operational environment, according to one embodiment of the present invention. In this particular illustration the functionality of a server is placed within dispatch center 101. As shown in FIG. 1 a plurality of public-safety vehicles 104-107 are in communication with dispatch center 101 (serving as server 101) through intervening network 102. Public-safety vehicles 104-107 may comprise such vehicles as rescue vehicles, ladder trucks, ambulances, police vehicles, fire engines, automobiles, motorcycles, . . . , etc. Network 102 may comprise one of any number of over-the-air or wired networks. For example network 102 may comprise a private 802.11 network set up by a building operator, a next-generation cellular communications network operated by a cellular service provider, or any public-safety network such as an APCO 25 network or the FirstNet broadband network.

As shown in FIG. 1, items 103 are provided. In this particular embodiment, items 103 comprise cameras, however, in alternate embodiments of the present invention items 103 may comprise any item where information on or from that item can be provided to a user. For example, items 103 may comprise businesses, restaurants, crime scenes, Compute-Aided-Dispatch incidents, fire hydrants, network fiber connections, gas stations, . . . , etc. Information on such items may comprise, a location, a network or street address, data provided by the item, audio, video, a menu, an access code or password, a telephone number, . . . , etc.

In this particular embodiment, cameras 103 provide video images to dispatch center 101 through intervening network 102. More particularly, cameras 103 electronically capture a sequence of video frames (i.e., a sequence of one or more still images), with optional accompanying audio, in a digital format. These video frames are sent from camera 103 to dispatch center 101 through network 102. Along with video frames, a camera ID and/or camera location is also provided to server 101.

Dispatch center 101, serving as a server, determines cameras of interest for a particular vehicle, and streams video from the camera of interest to vehicles 104-107. It should be noted that video from different cameras may be simultaneously streamed to different vehicles. For example, vehicle 104 may receive video from a first camera, while vehicles 105 receives video from a second camera. Additionally, multiple vehicles may receive the same video from a same camera of interest. It should be further noted that the server may not automatically start streaming video without intervention or acceptance from the user operating the vehicle.

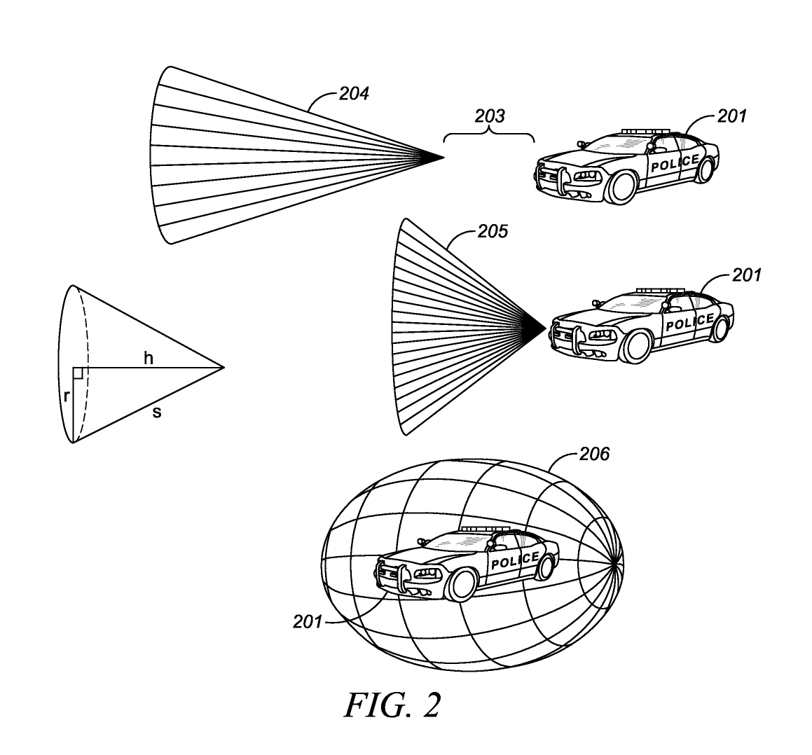

FIG. 2 illustrates a changing figure, shape, or region based on speed and direction of travel. In this particular embodiment a cone is utilized as the figure, shape, or region for example purposes only. One of ordinary skill in the art will recognize that any two-dimensional or three-dimensional figure, shape, or region may be utilized as described. In FIG. 2, when vehicle 201 is traveling at a high rate of speed (a first speed), all items within cone 204 will be identified as items of interest. For example, all cameras 103 lying within cone 204 will be identified as cameras of interest by server 101. Server 101 will then provide vehicle 201 information from a closest camera within the cone. It should be noted that cone 204 is not necessarily drawn to scale. Cone 204 may have a height and radius on the order of several miles in length.

As vehicle 201 slows down, the figure, shape, or region will change shape. This is shown in FIG. 2 as cone 204 changing shape to cone 205. In this particular embodiment, the height and radius of cone 204 will change as the speed of vehicle 201 changes, with the height of the cone pointed in the direction of travel. In this particular embodiment, the radius of cone 204 increases with decreasing vehicle speed while the height of cone 204 decreases with decreasing vehicle speed. This is illustrated as cone 205. As is evident, when vehicle 201 slows down, the figure, shape, or region used to determine items of interest changes shape from a first shape to a second shape.

It should be noted that the same figure or shape need not be used for all speeds. As illustrated in FIG. 2, when vehicle 201 is stopped (or moving at a speed below a threshold), spheroid 206 may be utilized as the shape used to determine items of interest. Thus, when vehicle 201 is stopped, all cameras within spheroid 206 are identified as cameras of interest. Again, spheroid 206 is not necessarily drawn to scale, and may have radiuses on the order of miles in length.

It should also be noted that the figure, shape, or region utilized for determining items of interest may be geographically located a predetermined distance 203 from vehicle 201. This distance may also change, depending upon the speed of vehicle 201. So, for example, when traveling at a higher rate of speed, cone 204 begins a greater distance 203 (e.g., a mile) from vehicle 201 than when travelling at a lower speed. Distance 203 decreases as speed of vehicle 201 decreases, reaching zero as the vehicle slows below a predetermined threshold.

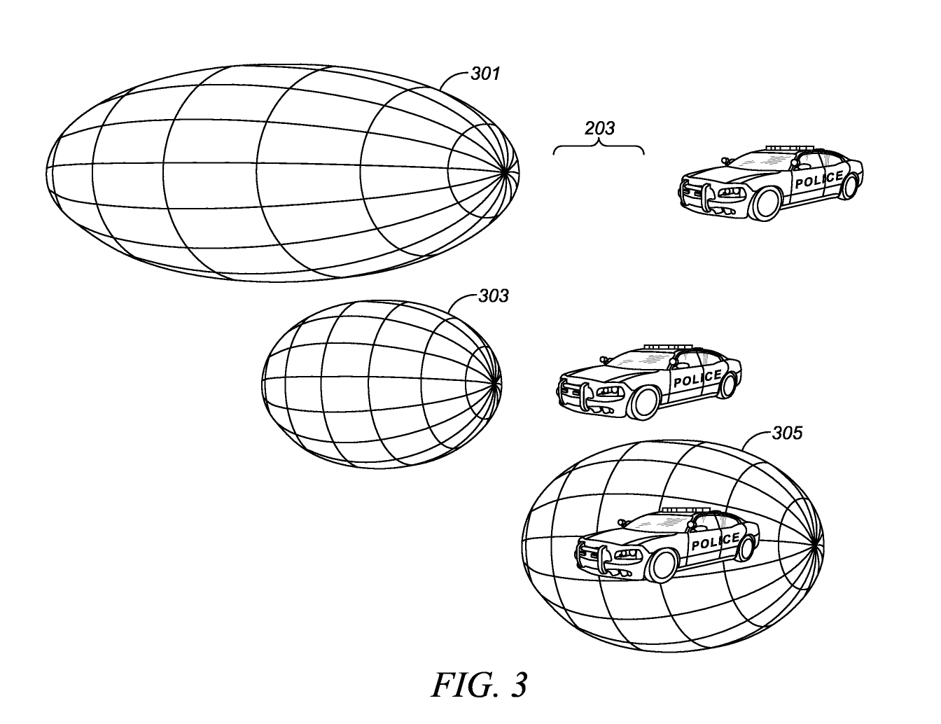

FIG. 3 illustrates a changing geometric shape based on speed and direction of travel. Unlike the cone utilized in FIG. 2, FIG. 3 utilizes a spheroid. As mentioned above, spheroids 301-305 are not necessarily drawn to scale. Server 101 will identify items within the spheroid as potential items of interest. The spheroid begins a predetermined distance 203 from the vehicle (again, not drawn to scale). This distance is based upon the speed of the vehicle. As with FIG. 2, the spheroid changes shape and size based on the speed of the vehicle. As shown, spheroids 301, 303, and 305 all have differing axis values based on vehicle speed, with an axis pointing in a direction of travel.

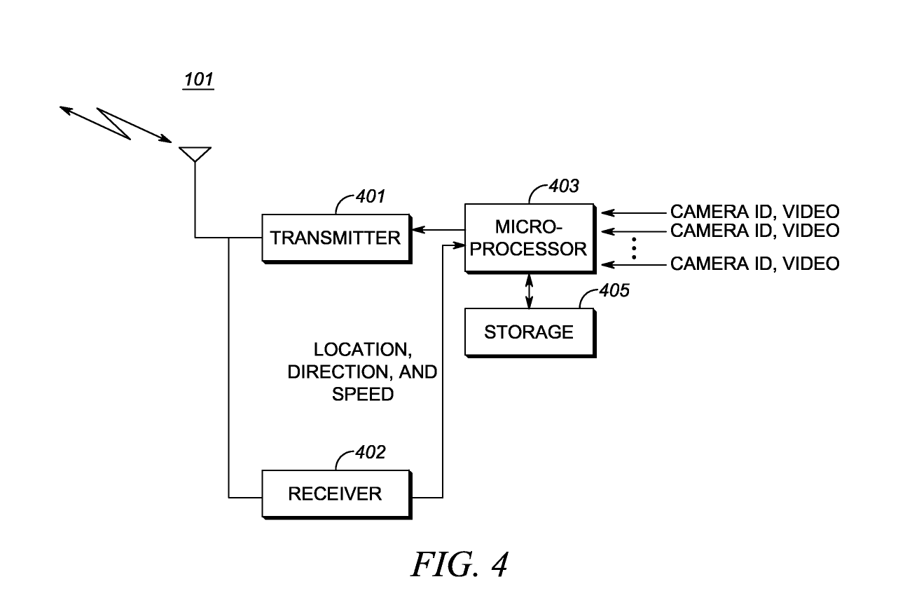

FIG. 4 is a block diagram of dispatch center 101 (or server 101) of FIG. 1. As shown, server 101 comprises microprocessor 403 that is communicatively coupled with various system components, including transmitter 401, receiver 402, and general storage component 405. Other components may be present, but not shown. Microprocessor 403, serving as logic circuitry 403, comprises a digital signal processor (DSP), general purpose microprocessor, a programmable logic device, or application specific integrated circuit (ASIC) and is utilized to determine a figure, shape, or region based on vehicle speed, determine items of interest within the figure, shape, or region, and provide information on items within the figure, shape, or region.

Storage 405 comprises standard random access memory and is used to store information related to items of interest along with a geographic map of a region. More particularly, storage 405 may comprise an area-wide map of a city and its surroundings. Potential items of interest may be identified on the map. For example, storage 405 may comprise an area-wide map of Chicago with locations for all cameras superimposed on the map.

Transmitter 401 and receiver 402 are common circuitry known in the art for communication utilizing a well known communication protocol, and serve as means for transmitting and receiving data. Examples of well known communication protocols include LTE, TETRA/TEDS, and 802.11.

During operation receiver 402 will receive a location, direction, and speed of a vehicle. In an alternate embodiment, route information may also be received. Route information may indicate future turns/streets for the vehicle. As is commonly known in the art, modern CAD systems generate a route for vehicles. This information may be provided to receiver 402 as part of a fleet-management protocol, or periodically from location-finding equipment (not shown) located within the vehicle. Once received, the information will be provided to logic circuitry 403. Logic circuitry will then determine a figure, shape, or region based on the location, direction, and speed of the vehicle. Logic circuitry 403 will then retrieve a map from storage 405 and overlay the shape/figure on the map at substantially the location of the vehicle. All items within the shape/figure will then be identified by logic circuitry 403 as items of interest. Alternatively, logic circuitry 403 will query a database of geo-tagged items stored on storage 405 to find items of interest within the shape/figure. Information on all or some of these items may then be provided to the vehicle/user.

In the particular embodiment where the items comprise video cameras, logic circuitry 403 will also receive a camera identification and video from multiple cameras. The location of the cameras may be known and stored in storage 405, or the location of the cameras may be provided along with the video and camera ID. All cameras within the shape/figure will then be identified by logic circuitry as cameras of interest. A video stream from a camera of interest is then transmitted (or relayed) to the vehicle by transmitter 401. The video stream chosen is preferably the closest camera of interest to the vehicle.

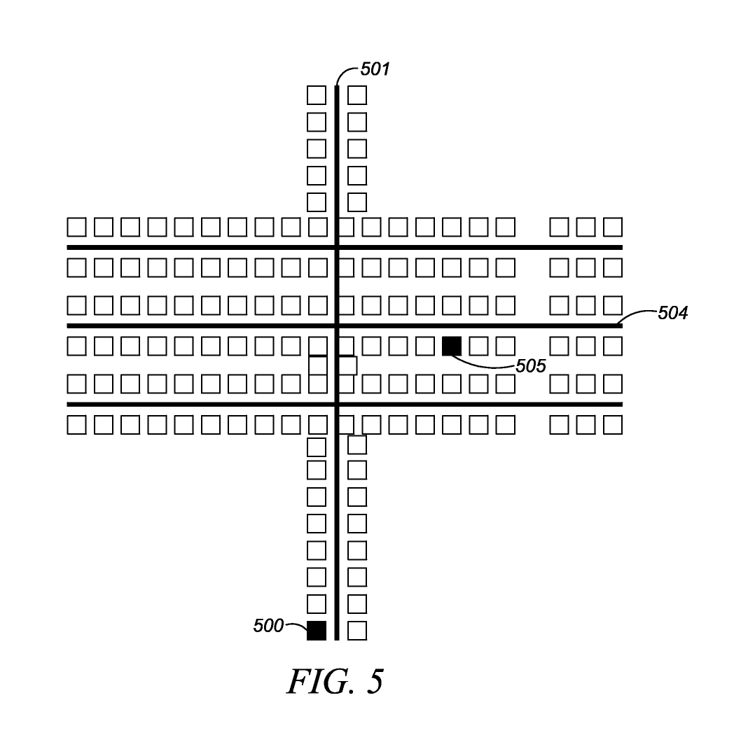

Thus, as described, the apparatus shown in FIG. 4 provides a receiver receiving a location and speed of a vehicle, logic circuitry determining a figure shape or region based on the speed, using the location to determine items within the figure, shape, or region, wherein the figure, shape, or region has a shape that changes with vehicle speed, and a transmitter providing information on/from an item within the figure, shape, or region. This process is illustrated in FIG. 5 through FIG. 8.

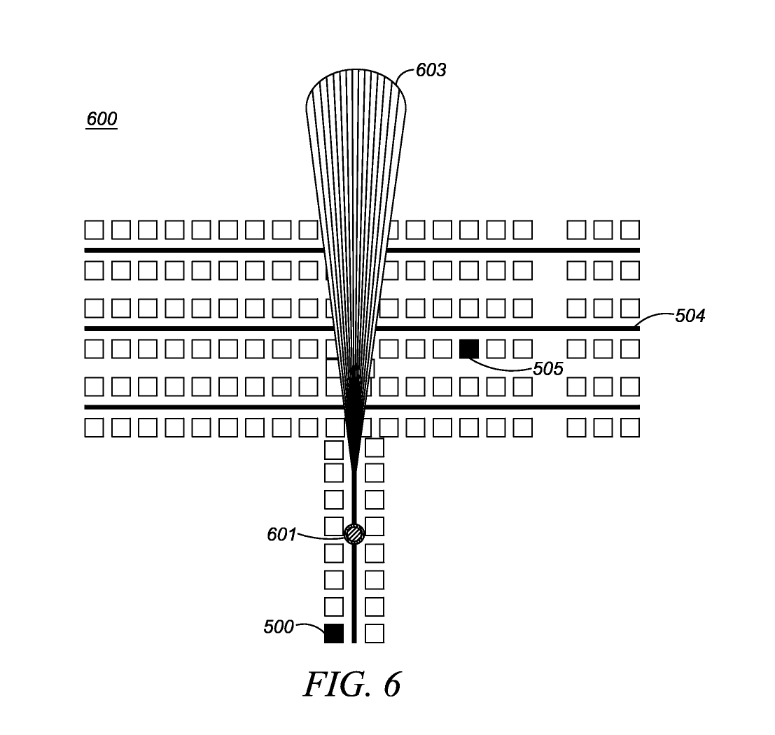

With reference to FIG. 5, assume that a vehicle is located near building 500 and will be traveling to building 505 via streets 501 and 504. Building 500 may comprise the location of, for example, a police station. Dispatch center 101 will receive video streams from cameras (not shown) within the geographic region shown in FIG. 5. In response, dispatch center 101 will receive a speed of the vehicle (preferably from the vehicle itself), receive a direction of travel for the vehicle (preferably from the vehicle itself), and receive a location of the vehicle (preferably from the vehicle itself). Dispatch center 101 will then determine a figure, shape, or region based on the speed and direction of travel. A distance 203 from the vehicle may also be determined based on the speed. Dispatch center 101 will then overlay the shape/figure on the map at the appropriate location. This is illustrated in FIG. 6, with a cone being used as the figure, shape, or region.

As shown in FIG. 6, the vehicle is located at point 601. Cone 603 is overlaid onto map 600. Dispatch center 101 will then determine all cameras lying within cone 603. These will be tagged as cameras of interest by dispatch center 101. An appropriate video stream will then be provided or made available to the vehicle.

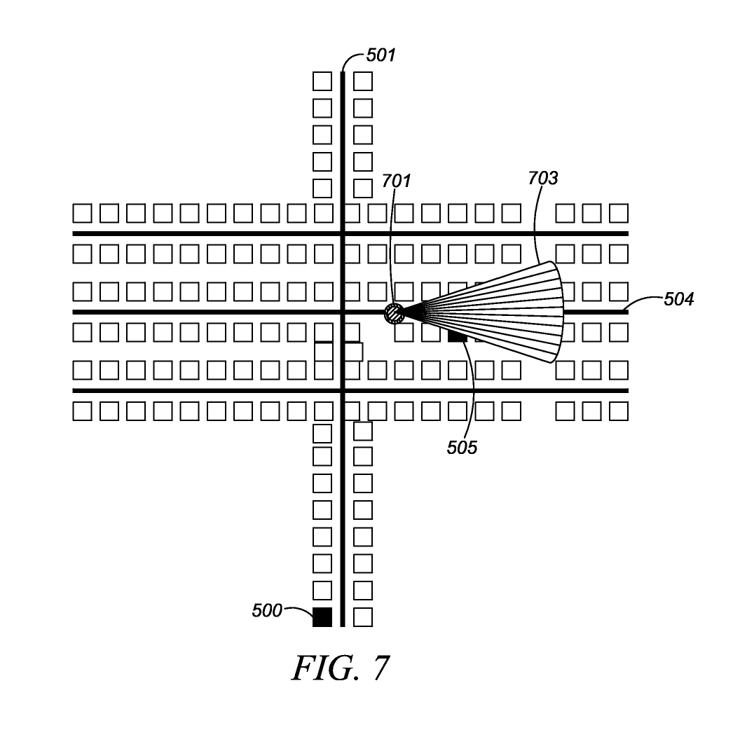

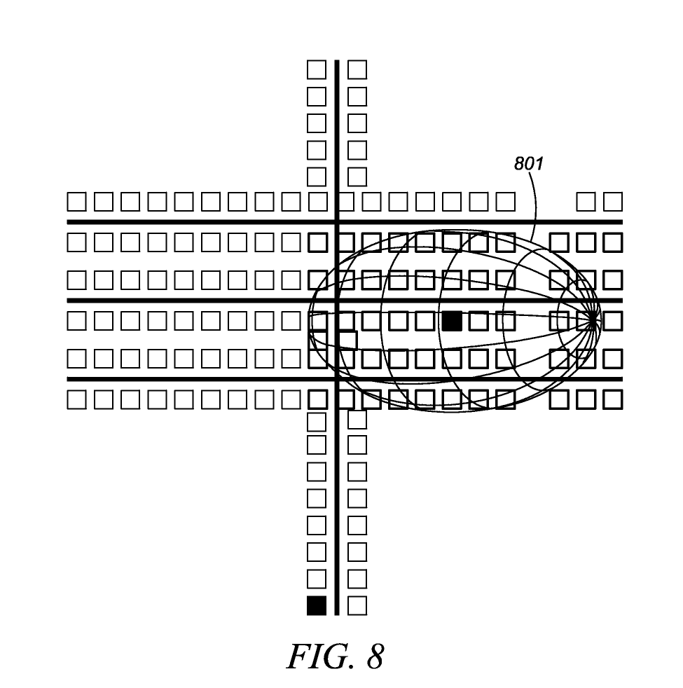

As the vehicle changes speed and location, cone 603 may morph into various shapes and sizes. This is illustrated in FIG. 7. As vehicle has moved to location 701 and reduces its speed, shape 603 has morphed into shape 703. Dispatch center 101 will then determine all cameras lying within cone 703. These will be tagged as cameras of interest by dispatch center 101. When the vehicle stops, the figure, shape, or region may change from one geometric shape to another. This is illustrated in FIG. 8, with spheroid 801 replacing cones 603 and 703.

As discussed above, the figure, shape, or region may comprise a two-dimensional shape. As the vehicle moves along, the two-dimensional shape should be covering items of interest falling within a certain angle around the line of motion (coverage angle, x°). If x=360° (which would be the default configuration), then an entire circle around the vehicle is covered. However, preferably this angle would narrow as speed increases so that upcoming cameras would be given higher priority over passed cameras. So, for example, at 50 miles per hour, x=60°. The vehicle will be sent information on items of interest that cover a narrow forward-looking 60° sector from the vehicle's current location. (Forward looking direction is calculated based on line of motion and velocity vector of vehicle movement).

As discussed above, the “range” of the shape may change with speed so as the vehicle moves along, items of interest should fall within a certain range from the vehicle. The range increases with speed.

As discussed above, in a particular embodiment, only information on one item of interest is provided to the vehicle. More particularly, a video stream from a single camera of interest is provided to the vehicle. In a first embodiment, the video stream is from a closest camera of interest. It should be noted, however, that information from multiple items of interest may be provided to the vehicle simultaneously. So, for example, if the vehicle comprises multiple video-displays, feeds from multiple cameras may be provided to the vehicle.

As is evident, as a vehicle moves about a geographic area and changes its direction and speed, information on different items of interest will be provided to the vehicle. In order to prevent the information from changing too quickly, a limit on how quickly information can change may be utilized. For example, a minimal time during which current camera must play a video stream after a camera leaves the area of interest may be set. Hold-off time is preferably configurable by user, but the server may decide the hold-off time automatically.

In one particular embodiment two videos streams are provided; one is always ‘dynamic’ (changing as described above), while the other may ‘hold’ for some time. In an alternate embodiment, the two video feeds may be provided based on cameras of interest that lie within two, differing geometric figure, shape, or regions. For example, a first feed may be provided that chooses cameras from a first geometric figure, shape, or region, while a second feed may be provided that shows cameras from a second figure, shape, or region. For example, one stream shows what is 1 mile in front of the vehicle, while the other shows what is 5 feet in front of the vehicle.

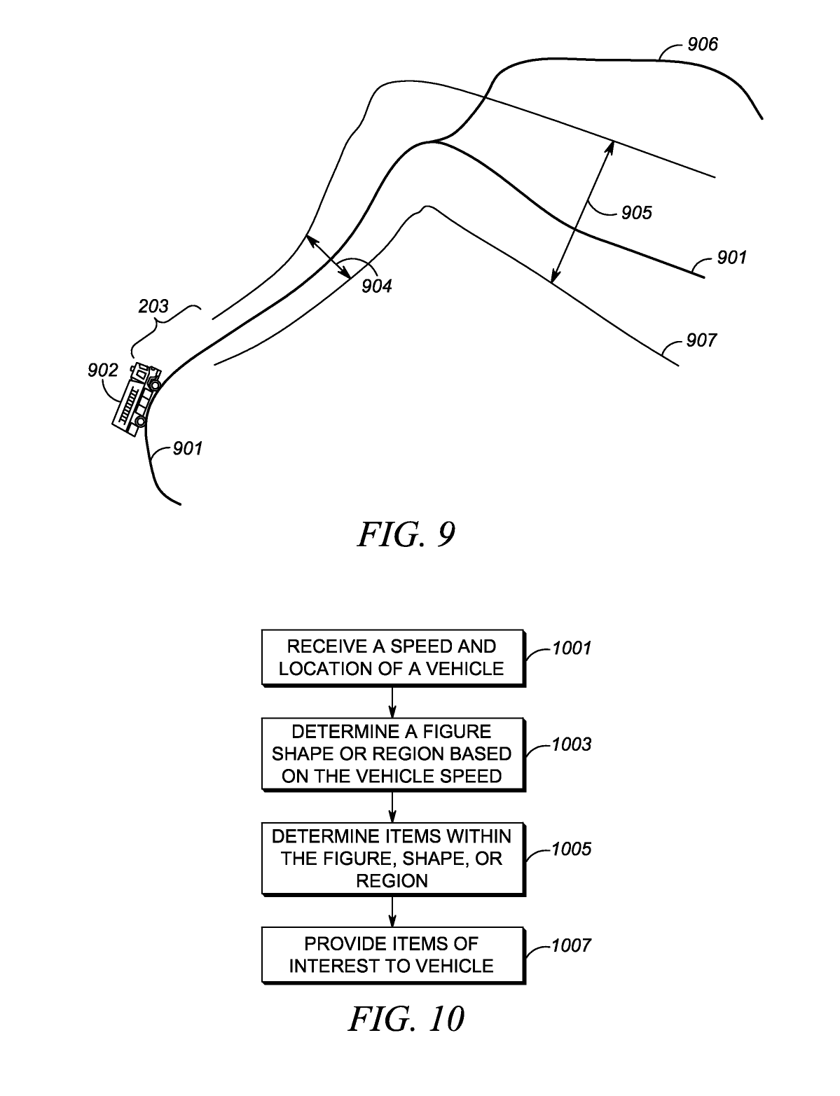

FIG. 9 illustrates a changing geometric shape based on speed and direction of travel in accordance with another embodiment of the present invention. In this particular embodiment, the figure, shape, or region encompasses all items within a predetermined distance from a route. In FIG. 9, vehicle 902 is travelling on a route that takes it down road 901. Vehicle 902 will continue down road 901 after reaching the intersection between roads 901 and 906. If route information is known by dispatch center 101, a figure, shape, or region 907 that is centered on road 901 may be determined. As described above, figure, shape or region 907 will have a shape determined by a speed of vehicle 902. Thus, figure, shape, or region 907 may have a first width 904 that is narrower than a second width 905. With the width increasing as distance increases from vehicle 902. As shown, figure, shape, or region 907 begins a distance 203 from vehicle 902, with distance 203 being based on vehicle speed.

FIG. 10 is a flow chart showing operation of dispatch center 101. More particularly, FIG. 10 shows a method for forwarding items of interest. The logic flow begins at step 1001 where receiver 402 receives a speed and location of a vehicle. Heading information may be received at step 1001 as well. For instance, the received “speed” may comprise a vector that indicates direction. This is preferable received via receiver 402 receiving step of receiving vehicle telemetry data from the vehicle via network 102. At step 1003 logic circuitry 403 determines a figure shape or region based on the vehicle speed. Using the location and/or heading of the vehicle, logic circuitry 403 then determines items within the figure, shape, or region (step 1005). This is preferably accomplished as described above by placing the figure, shape, or region over a geographic area. The figure, shape, or region may be aligned (e.g., have an axis aligned) with the heading. Information on/from an item within the figure, shape, or region is then provided to a vehicle (step 1007). More particularly, logic circuitry 403 instructs transmitter 401 to wirelessly transmit this information to a vehicle.

As discussed above, the figure, shape, or region has a shape that changes with vehicle speed. Additionally, the figure, shape or region begins at a distance from the vehicle, wherein the distance is based on the vehicle speed. The figure, shape, or region can also be based on a predetermined route to be taken by the vehicle as shown in FIG. 9.

In a particular embodiment, the predetermined figure, shape, or region extends an increasing distance from the route as the route's distance increases from the vehicle.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for forwarding items of interest, the method comprising the steps of:
receiving a speed and location of a vehicle;
determining a figure shape or region based on the vehicle speed;
using the location of the vehicle to determine items within the figure, shape, or region;
providing information on/from an item within the figure, shape, or region; and
wherein the figure, shape, or region has a shape that changes with vehicle speed.

2. The method of claim 1 wherein the figure, shape or region begins at a distance from the vehicle, wherein the distance is based on the vehicle speed.

3. The method of claim 2 wherein the figure, shape, or region is also based on a predetermined route to be taken by the vehicle.

4. The method of claim 3 wherein the predetermined figure, shape, or region extends an increasing distance from the route as the route's distance increases from the vehicle.

5. The method of claim 1 wherein the figure, shape, or region is a cone.

6. The method of claim 1 wherein the figure, shape, or region changes from a first shape to a second shape as the vehicle slows down.

7. The method of claim 1 wherein the step of determining the speed of the vehicle comprises the step of receiving vehicle telemetry data from the vehicle.

8. The method of claim 1 wherein the information on/from the item comprises a camera stream from a camera.

9. A method for forwarding a camera stream to a vehicle, the method comprising the steps of:
receiving a speed of the vehicle;
receiving a location of the vehicle;
determining a figure shape or region based on the speed of the vehicle;
using the location of the vehicle to determine cameras within the figure, shape, or region;
providing the camera stream from a camera within the figure, shape, or region; and
wherein the figure, shape, or region has a shape that changes with vehicle speed and wherein the figure, shape or region begins at a distance from the vehicle that increases with vehicle speed.

10. The method of claim 9 wherein the figure, shape, or region is also based on a predetermined route to be taken by the vehicle.

11. The method of claim 9 wherein the figure, shape, or region is conical.

12. The method of claim 9 wherein the figure, shape, or region changes from a first shape to a second shape as the vehicle slows down.

13. The method of claim 9 wherein the step of determining the speed of the vehicle comprises the step of receiving vehicle telemetry data from the vehicle.

14. An apparatus comprising:
a receiver receiving a location and speed of a vehicle;
logic circuitry determining a figure shape or region based on the speed, using the location to determine items within the figure, shape, or region, wherein the figure, shape, or region has a shape that changes with vehicle speed; and
a transmitter providing information on/from an item within the figure, shape, or region.

15. The apparatus of claim 14 wherein the figure, shape or region begins at a distance from a vehicle, wherein the distance is based on the vehicle speed.

16. The apparatus of claim 15 wherein the logic circuitry also determines a route for the vehicle, and the figure, shape, or region is also based on the route.

17. The apparatus of claim 16 wherein the predetermined figure, shape, or region extends an increasing distance from the route as the route's distance increases from the vehicle.

18. The apparatus of claim 14 wherein the figure, shape, or region is conical.

19. The apparatus of claim 14 wherein the figure, shape, or region changes from a first shape to a second shape as the vehicle slows down.

20. The apparatus of claim 14 wherein the wherein the information on/from the item comprises a camera stream from a camera.
